(19) United States
(12) Patent Application Publication
(10) Pub. No.: US 2026/0316954 A1
(43) Pub. Date: Oct. 15, 2026

(54) SYSTEMS AND METHODS FOR DETECTION OF INCONSISTENCIES IN AERONAUTICAL DATA

(71) Applicant: HONEYWELL INTERNATIONAL INC., Charlotte, NC (US)

(72) Inventors: Subash Samuthirapandian, Bangalore (IN); Ivan Sandy Wyatt, Phoenix, AZ (US); Ramani Mangipudi, Bangalore (IN)

(73) Assignee: HONEYWELL INTERNATIONAL INC., Charlotte, NC (US)

(21) Appl. No.: 19/249,031

(22) Filed: Jun. 25, 2025

(30) Foreign Application Priority Data
Apr. 14, 2025 (IN) 202511035953

(51) Int. Cl. B64D 45/00; B64F 5/60

(52) U.S. Cl. CPC B64D 45/00; B64F 5/60; B64D 2045/0085

(57) ABSTRACT

Systems and methods are provided for monitoring aeronautical data onboard an aircraft for inconsistencies. The systems include a communication system, a media system, and a controller configured to receive aeronautical data from at least two sources, wherein the aeronautical data includes information indicative of statuses of one or more aeronautical elements, parse the aeronautical data to generate parsed aeronautical data having the information contained therein having matching formats, identify statuses of the one or more aeronautical elements as indicated by each of the sources, compare the statuses, detect an inconsistency between the statuses of a first aeronautical element, and generate, on the media system, an alert in response to detecting the inconsistency between the statuses of the first aeronautical element.

### CROSS REFERENCE TO RELATED APPLICATION

This application claims priority to India Provisional Patent Application No. 202511035953, filed Apr. 14, 2025, the entire content of which is incorporated by reference herein.

### TECHNICAL FIELD

The present invention generally relates to aircraft navigation, and more particularly relates to systems and methods for detecting inconsistencies in aeronautical data and generating alerts in response to detection of the inconsistencies.

### BACKGROUND

Various systems are provided onboard aircraft that are intended to promote position situational awareness and aid pilots in navigation both in-air and on-ground (e.g., taxiing at an airport). These systems may use data received from several sources such as onboard or remote databases, air traffic controllers, controller-pilot data link communications (CPDLC), dispatch, chart/navigation/airport map databases, Notice to Airmen (NOTAM), automatic terminal information service (ATIS), common traffic advisory frequency (CTAF), and/or UNICOM. Since the data may be received from several sources, there exists a potential for inconsistencies in the data. For example, a particular source may indicate a taxiway at an airport is available whereas another source may indicate the same taxiway is closed. Hence, it is necessary for a pilot to understand the inconsistency, if one exists, prior to relying on the data.

Therefore, there is an ongoing desire for systems and methods that are capable of promoting a pilot's understanding of inconsistencies in data received from several sources. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In various examples, a method is provided for an aircraft. The method may include, by a controller having one or more processors onboard the aircraft: receiving aeronautical data from at least two sources remote from the aircraft via a communication system onboard the aircraft, wherein the aeronautical data includes information indicative of statuses of one or more aeronautical elements, parsing the aeronautical data to generate parsed aeronautical data having the information contained therein having matching formats, identifying statuses of the one or more aeronautical elements as indicated by each of the at least two sources in the parsed aeronautical data, comparing the statuses of the one or more aeronautical elements, detecting an inconsistency between the statuses of a first aeronautical element of the one or more aeronautical elements, and generating an alert on a media system of the aircraft in response to detecting the inconsistency between the statuses of the first aeronautical element.

In various examples, a system is provided onboard an aircraft. The system includes a communication system configured to provide for communication with one or more external sources, a media system, and a controller functionally coupled with the communication system and the media system. The controller is configured to, with one or more processors: receive, via the communication system, aeronautical data from at least two sources, wherein the aeronautical data includes information indicative of statuses of one or more aeronautical elements, parse the aeronautical data to generate parsed aeronautical data having the information contained therein having matching formats, identify statuses of the one or more aeronautical elements as indicated by each of the at least two sources in the parsed aeronautical data, compare the statuses of the one or more aeronautical elements, detect an inconsistency between the statuses of a first aeronautical element of the one or more aeronautical elements, and generate, on the media system, an alert in response to detecting the inconsistency between the statuses of the first aeronautical element.

In various examples, an aircraft is provided that includes a communication system configured to provide for communication with one or more external sources, a media system, a controller functionally coupled with the communication system and the media system. The controller configured to, with one or more processors: receive, via the communication system, aeronautical data from at least two sources, wherein the aeronautical data includes information indicative of statuses of one or more aeronautical elements, parse the aeronautical data to generate parsed aeronautical data having the information contained therein having matching formats, identify statuses of the one or more aeronautical elements as indicated by each of the at least two sources in the parsed aeronautical data, compare the statuses of the one or more aeronautical elements, detect an inconsistency between the statuses of a first aeronautical element of the one or more aeronautical elements, generate an alert in response to detecting the inconsistency between the statuses of the first aeronautical element by transmitting control signals to produce a graphic, text, and/or audio message with the media system, and generate information indicating the inconsistency on the media system.

Furthermore, other desirable features and characteristics of the method, system, and aircraft will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 schematically represents a mobile platform and components of an aeronautical data monitoring system thereof in accordance with an embodiment;

FIG. 2 is a dataflow diagram illustrating operation of the aeronautical data monitoring system of FIG. 1 in accordance with an embodiment;

FIG. 3 is a flowchart illustrating an exemplary method for monitoring aeronautical data in accordance with an embodiment;

FIGS. 4-7 represent exemplary displays of a moving map application that illustrate various alerts and messages generated by an aeronautical data monitoring system in accordance with an embodiment;

FIGS. 8-11 represent exemplary displays of a flight management system that illustrate various alerts and messages generated by an aeronautical data monitoring system in accordance with an embodiment; and

FIGS. 12-14 represent exemplary displays of a multi-function control and display unit that illustrate various alerts and messages generated by an aeronautical data monitoring system in accordance with an embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods disclosed herein provide for monitoring of aeronautical data for inconsistencies therein for a mobile platform. The systems and methods may include receiving aeronautical data from sources remote from the mobile platform, parsing the aeronautical data, processing the parsed aeronautical data to identify, compare, and detect inconsistencies in statuses of aeronautical elements as indicated in the parsed aeronautical data, and generating an alert in response to detecting an inconsistency.

The mobile platform may be any type of vehicle, such as but not limited to various types of aircraft. It should be noted that the term aircraft, as utilized herein, may include any manned or unmanned object capable of flight. Examples of aircraft may include, but are not limited to, fixed-wing aerial vehicles (e.g., propeller-powered or jet powered), rotary-wing aerial vehicles (e.g., helicopters), manned aircraft, unmanned aircraft (e.g., unmanned aerial vehicles, or UAVs), delivery drones, etc. For convenience, the systems and methods will be described in reference to a manned airplane; however, as noted the systems and methods are not limited to such application.

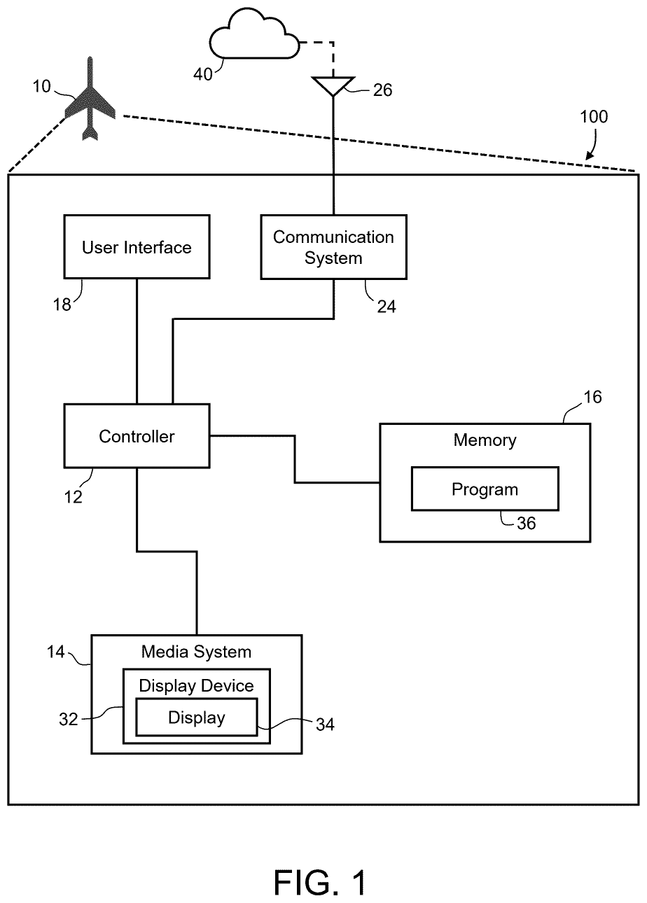

Referring now to FIG. 1, an aircraft 10, in this example an airplane, and certain systems thereof are illustrated in accordance with an exemplary and nonlimiting embodiment of the present disclosure. An aeronautical data monitoring system 100 may be utilized onboard the aircraft 10 as described herein. As schematically depicted in FIG. 1, the system 100 includes and/or is functionally coupled to the following components or subsystems, each of which may assume the form of a single device or multiple interconnected devices, including, but not limited to, a controller 12 operationally coupled to: at least one display device 32, which may optionally be part of a larger on-board media system 14; computer-readable storage media or memory 16; an optional user interface 18, and a communication system 24. The system 100 may be separate from or integrated within a flight management system (FMS) and/or a flight control system (FCS).

The term “controller,” as appearing herein, broadly encompasses those components utilized to carry-out or otherwise support the processing functionalities of the system 100. Accordingly, the controller 12 can encompass or may be associated with any number of individual processors, flight control computers, navigational equipment pieces, computer-readable memories (including or in addition to the memory 16), power supplies, storage devices, interface cards, and other standardized components.

In various embodiments, the controller 12 includes at least one processor, a communication bus, and a computer readable storage device or media. The processor performs the computation and control functions of the controller 12. The processor can be any custom made or commercially available processor, a central processing unit (CPU), a graphics processing unit (GPU), an auxiliary processor among several processors associated with the controller 12, a semiconductor-based microprocessor (in the form of a microchip or chip set), any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 12. The bus serves to transmit programs, data, status and other information or signals between the various components of the aircraft 10. The bus can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor, receive and process signals from the sensors 22, perform logic, calculations, methods and/or algorithms, and generate data based on the logic, calculations, methods, and/or algorithms. Although only one controller 12 is shown in FIG. 1, embodiments of the aircraft 10 can include any number of controllers 12 that communicate over any suitable communication medium or a combination of communication mediums and that cooperate to process the sensor signals, perform logic, calculations, methods, and/or algorithms, and generate data. In various embodiments, the controller 12 includes or cooperates with at least one firmware and software program (generally, computer-readable instructions that embody an algorithm) for carrying-out the various process tasks, calculations, and control/display functions described herein. During operation, the controller 12 may be programmed with and execute at least one firmware or software program, for example, a program 36, that embodies one or more algorithms, to thereby perform the various process steps, tasks, calculations, and control/display functions described herein.

The controller 12 may exchange data with one or more external sources 40 to support operation of the system 100 in various embodiments. In this case, bidirectional wireless data exchange may occur via the communication system 24 over a communications network, such as a public or private network implemented in accordance with Transmission Control Protocol/Internet Protocol architectures or other conventional protocol standards. Encryption and mutual authentication techniques may be applied, as appropriate, to ensure data security. In various embodiments, the communication system 24 is configured to support instantaneous (i.e., real time or current) communications between on-board systems, the controller 12, and the one or more external sources 40 via an antenna 26. The communication system 24 may incorporate one or more transmitters, receivers, and the supporting communications hardware and software required for components of the system 100 to communicate as described herein. In various embodiments, the communication system 24 may have additional communications not directly relied upon herein.

The memory 16 can encompass any number and type of storage media suitable for storing computer-readable code or instructions, such as the program 36, as well as other data generally supporting the operation of the system 100. As can be appreciated, the memory 16 may be part of the controller 12, separate from the controller 12, or part of the controller 12 and part of a separate system. The memory 16 can be any suitable type of storage apparatus, including various different types of direct access storage and/or other memory devices.

With continued reference to FIG. 1, the display device 32 can include any number and type of image generating devices on which one or more avionic displays 34 may be produced. In various embodiments, the display device 32 may be affixed to the static structure of the aircraft 10 cockpit as, for example, a Head Down Display (HDD) or Head Up Display (HUD) unit. Alternatively, the display device 32 may assume the form of a movable display device (e.g., a pilot-worn display device) or a portable display device, such as an Electronic Flight Bag (EFB), a laptop, or a tablet computer carried into the aircraft 10 cockpit by a pilot.

In addition to the display device 32, the media system 14 may include one or more speakers that may optionally be a component of a larger audio system. The audio system and/or the speakers may be configured to produce audible messages and/or sounds.

In some examples at least one avionic display 34 is generated on display device 32 during operation of the system 100. The term “avionic display” as used herein is synonymous with the terms “aircraft-related display” and “cockpit display” and encompasses displays generated in textual, graphical, cartographical, and other formats. The system 100 can generate various types of lateral and vertical avionic displays 34 on which symbology, text annunciations, and other graphics pertaining to flight planning are presented for a pilot to view. The display device 32 is configured to continuously render at least one avionic display 34 showing a terrain environment at a current location of the aircraft 10. The avionic display 34 generated and controlled by the system 100 can include alphanumerical input displays of the type commonly presented on the screens of multi-function control and display units (MCDUs), as well as Control Display Units (CDUs) generally. Specifically, certain embodiments of the avionic displays 34 include one or more two dimensional (2D) avionic displays, such as a horizontal (i.e., lateral) navigation display or vertical navigation display; and/or on one or more three dimensional (3D) avionic displays, such as a Primary Flight Display (PFD) or an exocentric 3D avionic display.

The optional user interface 18 may include any devices configured to allow data input by a user. In various embodiments, a human-machine interface, such as a touch screen display, is implemented as an integration of the user interface 18 and the display device 32. Via various display and graphics systems processes, the controller 12 may command and control the touch screen display generating a variety of graphical user interface (GUI) objects or elements, for example, buttons, sliders, and the like, which are used to prompt a user to interact with the human-machine interface to provide user input, and to activate respective functions and provide user feedback, responsive to received user input at the GUI element.

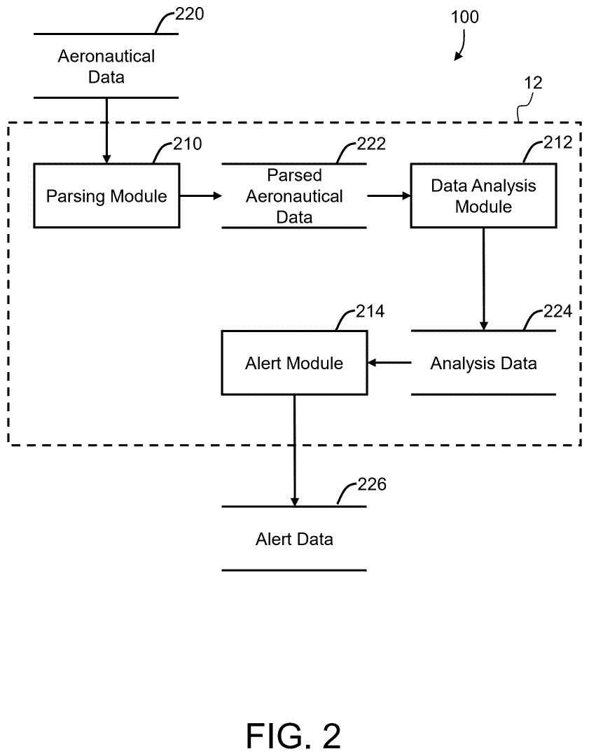

With reference to FIG. 2 and with continued reference to FIG. 1, a dataflow diagram illustrates elements of the system 100 of FIG. 1 in accordance with various embodiments. As can be appreciated, various embodiments of the system 100 according to the present disclosure may include any number of modules embedded within the controller 12 which may be combined and/or further partitioned to similarly implement systems and methods described herein. Furthermore, inputs to the system 100 may be received from other control modules (not shown) associated with the aircraft 10, and/or determined/modeled by other sub-modules (not shown) within the controller 12. Furthermore, the inputs might also be subjected to preprocessing, such as sub-sampling, noise-reduction, normalization, feature-extraction, missing data reduction, and the like. In various embodiments, the system 100 includes a parsing module 210, a data analysis module 212, and an alert module 214.

In various embodiments, the parsing module 210 receives as input aeronautical data 220 received by two or more sources received via the communication system 24. The aeronautical data 220 includes various data indicating information relating to aeronautical elements, such as statuses thereof. The parsing module 210 performs one or more data parsing processes to generate parsed aeronautical data 222 with the data and/or information contained therein having matching formats.

In various embodiments, the data analysis module 212 receives as input the parsed aeronautical data 222 generated by the parsing module 210. The data analysis module 212 processes the parsed aeronautical data 222 to identify status of the aeronautical elements, compare the status of the aeronautical elements as indicated by the various sources, and detect inconsistencies in the statuses. For example, a first source and a second source may indicate different statuses of a first aeronautical element indicating an inconsistency in the status of the first aeronautical element. The data analysis module 212 may generate analysis data 224 that includes various data indicative of any inconsistencies detected in the statuses of the aeronautical elements.

In various embodiments, the alert module 214 receives as input the analysis data 224 generated by the data analysis module 212. The alert module 214 processes the analysis data 224 and generates alert data 226 that includes instructions configured to cause the media system 14 to generate or produce an alert, such as a graphic, text, and/or audio message. In some examples, the alert data 226 may be configured to generate information indicating the inconsistency on the media system 14, such as a textual explanation displayed on the display device 32. The data analysis module 212 may transmit the alert data 226 to one or more other systems or devices onboard the aircraft 10, such as the media system 14.

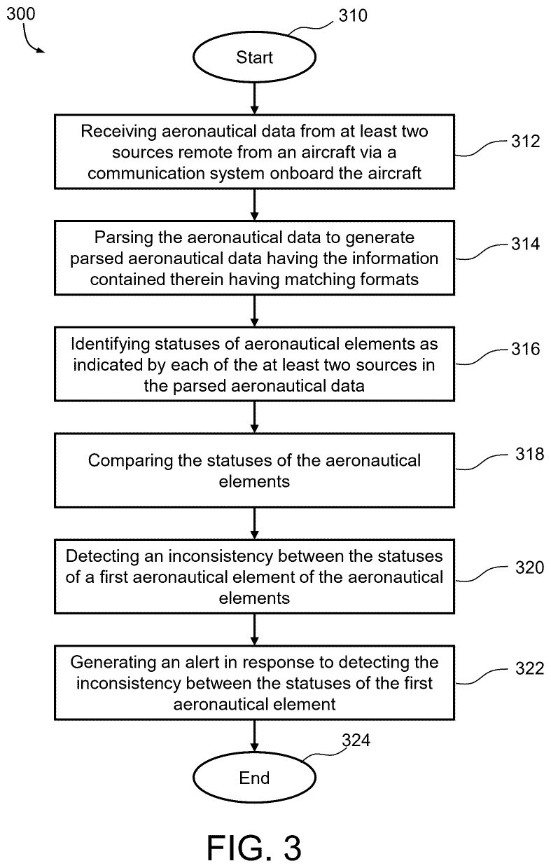

The systems disclosed herein, including the system 100, provide for methods of monitoring aeronautical data for inconsistencies. For example, FIG. 3 is a flowchart illustrating an exemplary method 300 for monitoring aeronautical data onboard an aircraft, such as the aircraft 10. The method 300 may start at 310. At 312, the method 300 may include receiving, with a controller having one or more processors onboard the aircraft, aeronautical data from at least two sources remote from the aircraft via a communication system onboard the aircraft. At 314, the method 300 may include parsing, with the controller, the aeronautical data to generate parsed aeronautical data having the information contained therein having matching formats. At 316, the method 300 may include identifying, with the controller, statuses of aeronautical elements as indicated by each of the at least two sources in the parsed aeronautical data. At 318, the method 300 may include comparing, with the controller, the statuses of the aeronautical elements. At 320, the method 300 may include detecting, with the controller, an inconsistency between the statuses of a first aeronautical element of the aeronautical elements. At 322, the method 300 may include generating, with the controller, an alert in response to detecting the inconsistency between the statuses of the first aeronautical element. The method 300 may end at 324.

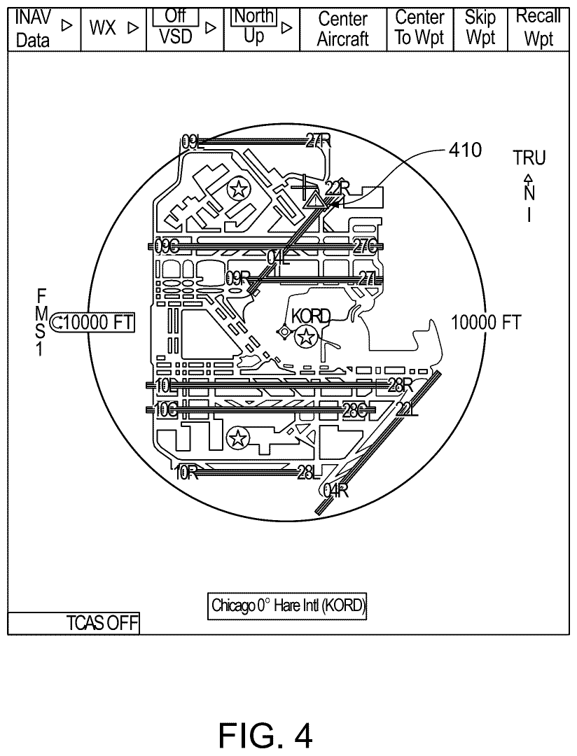

Referring now to FIGS. 4-13, various examples are provided that illustrate alerts and information relating to aeronautical data inconsistencies as generated by the systems and methods disclosed herein. Notably, the systems and methods are not limited to the various displays represented in FIGS. 4-13, and the alerts and information generated by the systems and methods are not limited to the graphics and text shown in FIGS. 4-13.

FIGS. 4-7 represent exemplary displays of a moving map application that illustrate various alerts and messages generated by an aeronautical data monitoring system, such as the system 100. The moving map application displays an aerial or top-down view of an airport with various taxiways, runways, and the like identified thereon.

In FIG. 4, a data conflict icon 410 is displayed adjacent to a runway 22R indicating that an inconsistency has been detected with the status of the runway 22R. In this example, the data conflict icon 410 includes an exclamation mark enclosed in a triangle; however, the data conflict icon 410 is not limited to this example. In some examples, the data conflict icon 410 may include aspects intended to draw attention to the data conflict icon 410. For example, the data conflict icon 410 may include a color that is visually distinct from the surrounding colors of the display. As another example, the data conflict icon 410 may flash or otherwise move to draw attention thereto.

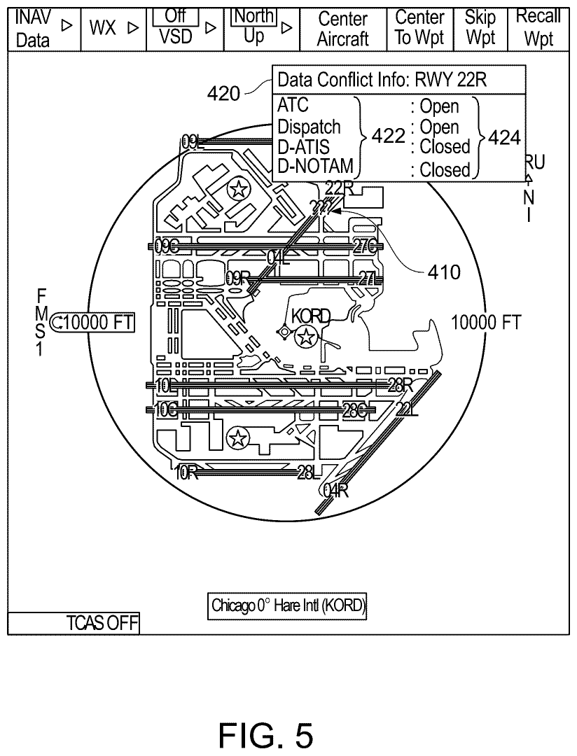

In some examples, the data conflict icon 410 may be interactive to allow a user (e.g., a pilot) to receive additional information relating to the detected inconsistency. For example, a user may select the data conflict icon 410 or hover a cursor of a pointing device over the data conflict icon 410. FIGS. 5-7 represent additional information displayed in conflict dialog boxes 420 on the displays in response to a request by the user. In some examples, the data conflict icon 410 and/or the conflict dialog box 420 may provide an indication of the severity of the data inconsistency. In FIGS. 5-7, the data conflict icon 410 is represented by three question marks.

In the example of FIG. 5, the status 424 of the runway 22R was received from four sources 422 (i.e., ATC, Dispatch, D-ATIS, and D-NOTAM) with two of the sources 422 indicating that the runway 22R is open and two of the sources 422 indicating that the runway 22R is closed. Based on this available information, it would be unknown whether the runway 22R is actually open or closed. Therefore, the data conflict icon 410 and/or portions of the conflict dialog box 420 (or text displayed therein) may have, for example, a red color to indicate a serious data inconsistency.

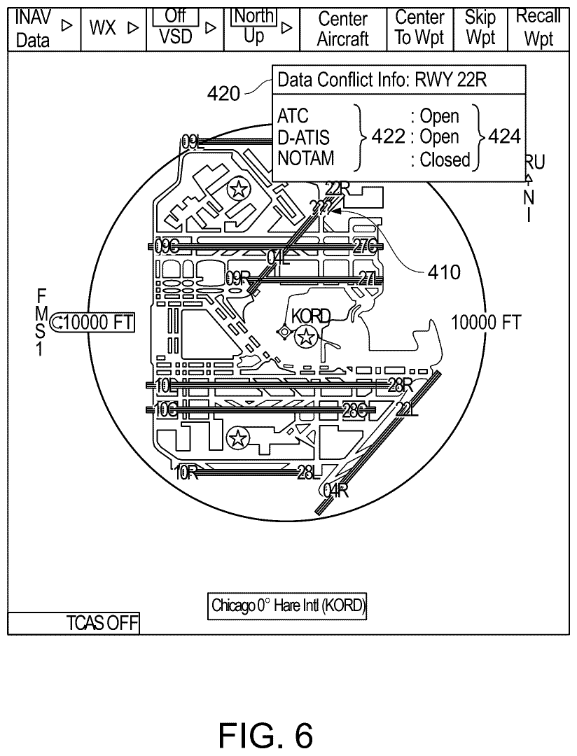

In the example of FIG. 6, the status 424 of the runway 22R was received from three sources 422 (i.e., ATC, D-ATIS, and NOTAM) with two of the sources 422 indicating that the runway 22R is open and one of the sources 422 indicating that the runway 22R is closed. Based on this available information, it may be inferred that the runway 22R is likely to be open since two of the three sources 422 agree. Therefore, the data conflict icon 410 and/or portions of the conflict dialog box 420 (or text displayed therein) may have, for example, an orange color to indicate a moderate data inconsistency.

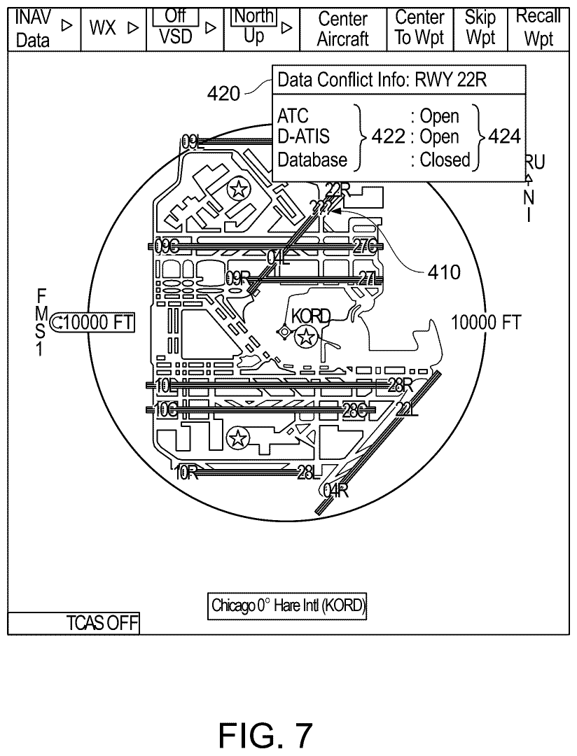

In the example of FIG. 7, the status 424 of the runway 22R was received from three sources 422 (i.e., ATC, D-ATIS, and an onboard database) with two of the sources 422 indicating that the runway 22R is open and one of the sources 422 (i.e., the onboard database) indicating that the runway 22R is closed. Based on this available information, it may be inferred that the runway 22R is likely to be open. Further, the onboard database may be updated at a much longer interval relative to the other sources 422, and the system may assume that the onboard database is incorrect. Therefore, the data conflict icon 410 and/or portions of the conflict dialog box 420 (or text displayed therein) may have, for example, a white color to indicate a minor data inconsistency.

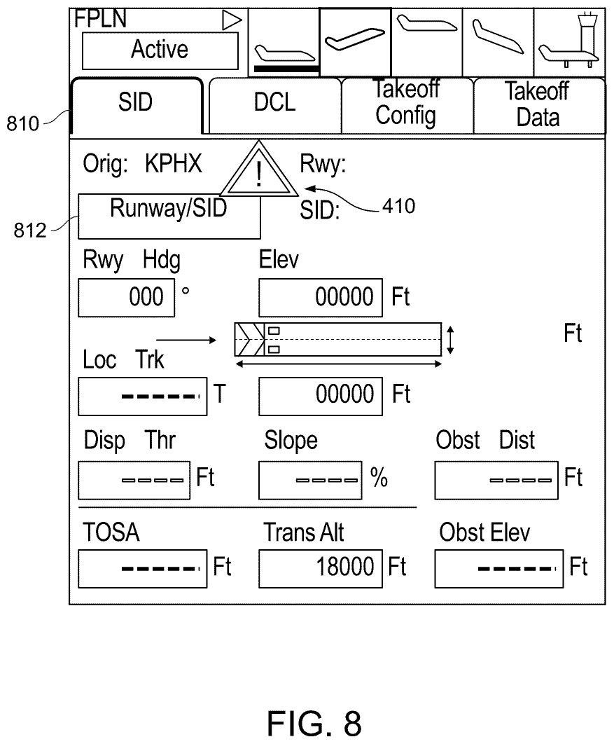

FIGS. 8-11 represent exemplary displays of a flight management system that illustrate various alerts and messages generated by an aeronautical data monitoring system, such as the system 100.

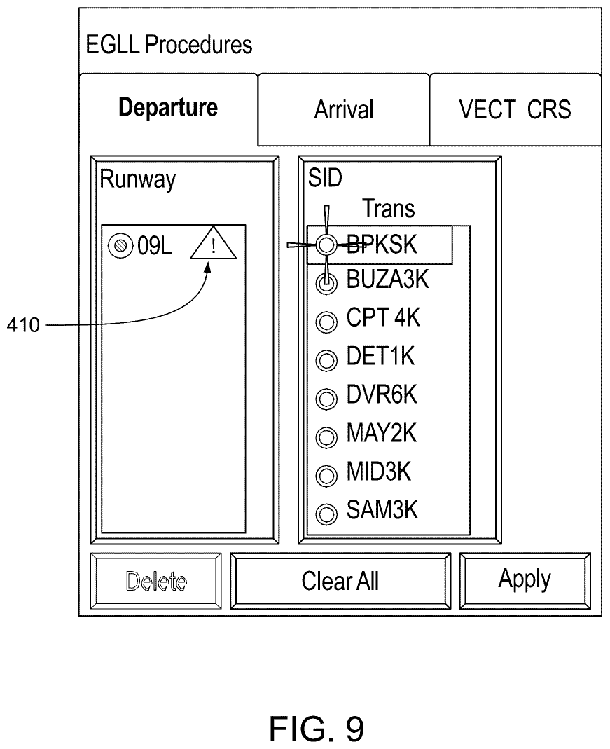

In FIG. 8, a Standard Instrument Departure Route (SID) tab 810 is displayed in the flight management system. A Runway/SID button 812 is provided that the user can select to open a Departure dialog box, as represented in FIG. 9. The Departure dialog box may include, for example, a list of runways and SIDs. If a data inconsistency is detected for one of the runways or SIDs listed in the Departure dialog box, the data conflict icon 410 may be displayed on the SID tab 810, for example, on or adjacent to the Runway/SID button 812. In some examples, the text of the Runway/SID button 812 may be changed to indicate the data inconsistency. In addition, or as an alternative, the data inconsistency may be indicated in the Departure dialog box. For example, the data conflict icon 410 may be displayed adjacent to the corresponding runway (e.g., as represented in FIG. 9) or SID. In some examples, the text of the runaway or the SID may be changed to indicate the data inconsistency.

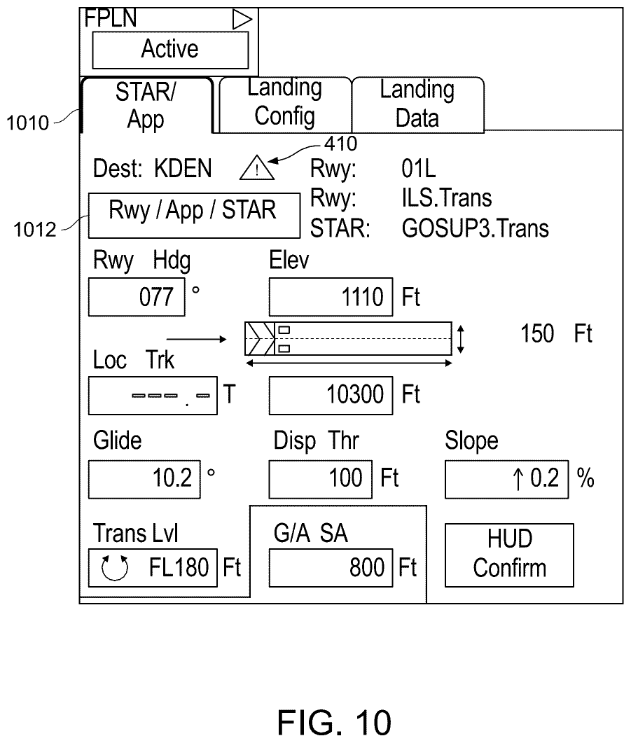

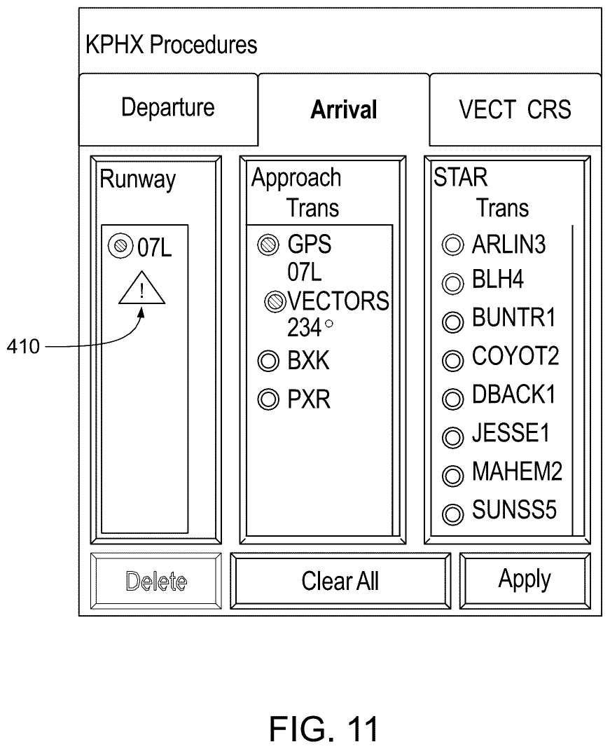

In FIG. 10, a Standard Arrival Route (STAR)/App tab 1010 is displayed in the flight management system. A Rwy/App/STAR button 1012 is provided that the user can select to open an Arrival/Approach dialog box, as represented in FIG. 11. The Arrival/Approach dialog box may include, for example, lists of runways, approaches, and arrivals. If a data inconsistency is detected for one of the runways, approaches, or arrivals listed in the Arrival/Approach dialog box, the data conflict icon 410 may be displayed on the STAR/App tab 1010, for example, on or adjacent to the Rwy/App/STAR button 1012 (e.g., as represented in FIG. 10). In some examples, the text of the Rwy/App/STAR button 1012 may be changed to indicate the data inconsistency. In addition, or as an alternative, the data inconsistency may be indicated in the Arrival/Approach dialog box. For example, the data conflict icon 410 may be displayed adjacent to the corresponding runway (e.g., as represented in FIG. 11), approach, or arrival. In some examples, the text of the runway, approach, or arrival may be changed to indicate the data inconsistency.

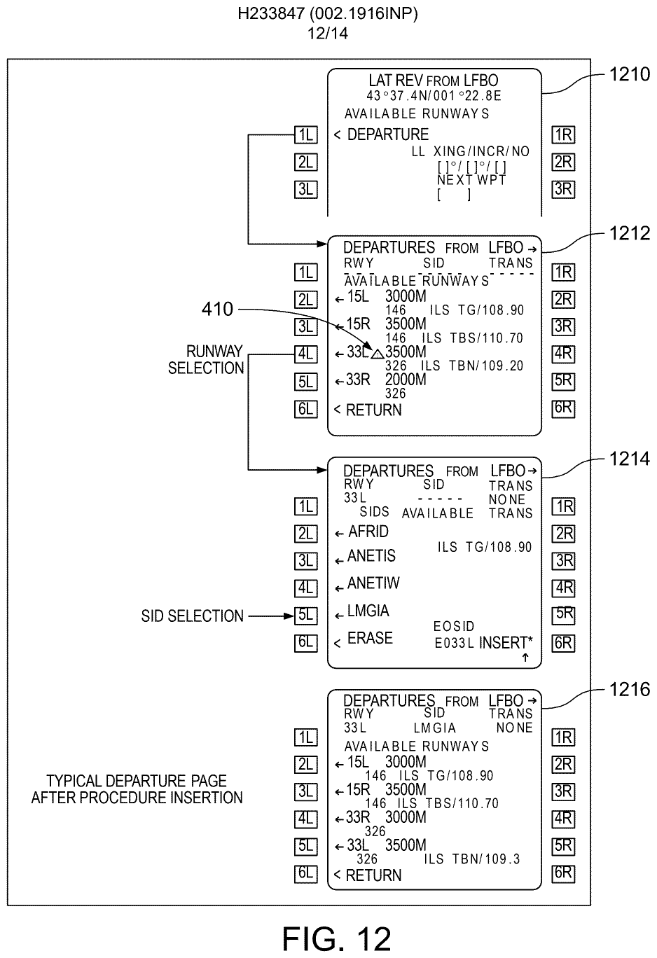

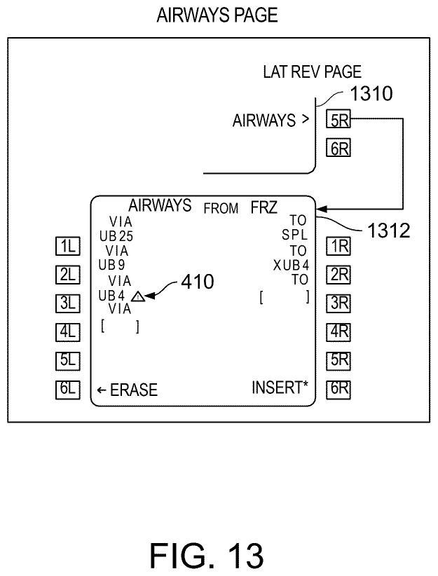

FIGS. 12-13 represent exemplary displays of a multi-function control and display unit that illustrate various alerts and messages generated by an aeronautical data monitoring system, such as the system 100.

In FIG. 12, a user has selected a departure option in a first display menu 1210, selected a runway option in a second display menu 1212, and selected an SID option in a third display menu 1214 which resulted in a departure page 1216. If a data inconsistency is detected for one of the runways or SIDs listed in the second display menu 1212 or the third display menu 1214, a data conflict icon 410 may be displayed in one or more of the first display menu 1210, the second display menu 1212 (e.g., as represented in FIG. 12), and the third display menu 1214 and/or the departure page 1216. In some examples, the data conflict icon may be displayed next to the runway or SID, and/or the text of the Runway or SID may be changed to indicate the data inconsistency.

In FIG. 13, a user has selected an airways option in a first display menu 1310 which resulted in an airways page 1312 that displays, for example, a list of airways. If a data inconsistency is detected for one of the airways listed in the airways page 1312, the data conflict icon 410 may be displayed in the first display menu 1310 and/or the airways page 1312 (e.g., as represented in FIG. 13). In some examples, the data conflict icon may be displayed next to the airway, and/or the text of the airway may be changed to indicate the data inconsistency.

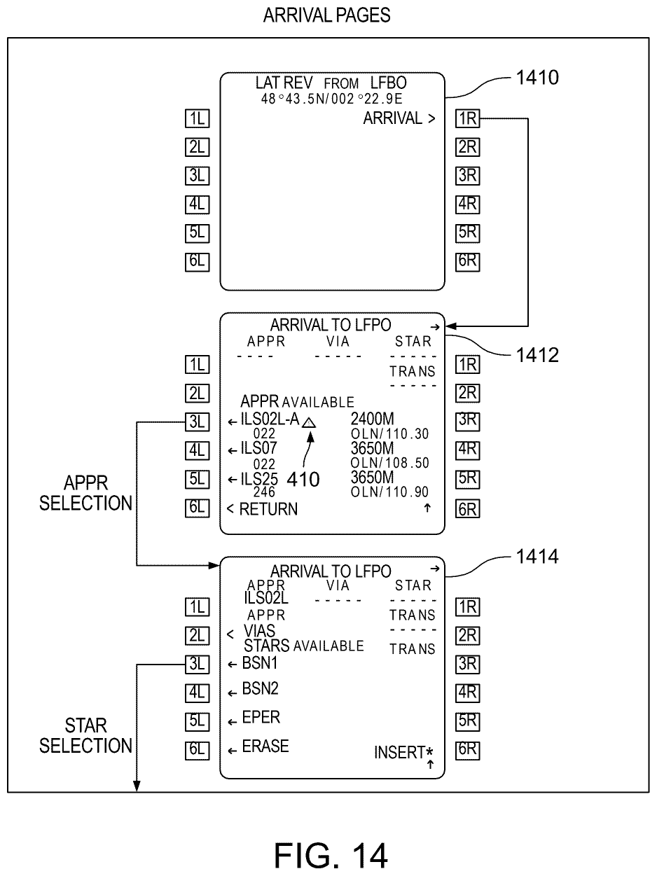

In FIG. 14, a user has selected an arrivals option in a first display menu 1410 and selected an APPR option in a second display menu 1412 which resulted in an arrivals page 1414 that displays, for example, a list of arrivals. If a data inconsistency is detected for one of the arrivals listed in the arrivals page 1414, a data conflict icon may be displayed in the first display menu 1410, the second display menu 1412 (e.g., as represented in FIG. 14), and/or the arrivals page 1414. In some examples, the data conflict icon may be displayed next to the arrival, and/or the text of the arrival may be changed to indicate the data inconsistency.

The systems and methods disclosed herein provide various benefits over certain existing systems and methods. For example, by detecting and alerting a user (e.g., a pilot) to inconsistencies in aeronautical data, the system and methods promote situational awareness and may significantly reduce a workload on the user during high stress operations.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for an aircraft, comprising:
receiving, by a controller having one or more processors onboard the aircraft, aeronautical data from at least two sources, wherein at least a first source of the at least two sources is remote from the aircraft and the controller receives the aeronautical data from the first source via a communication system onboard the aircraft, wherein the aeronautical data includes information indicative of statuses of one or more aeronautical elements;
parsing, with the one or more processors of the controller, the aeronautical data to generate parsed aeronautical data having the information contained therein having matching formats;
identifying, with the one or more processors of the controller, statuses of the one or more aeronautical elements as indicated by each of the at least two sources in the parsed aeronautical data;
comparing, with the one or more processors of the controller, the statuses of the one or more aeronautical elements;
detecting, with the one or more processors of the controller, an inconsistency between the statuses of a first aeronautical element of the one or more aeronautical elements; and
generating, with the one or more processors of the controller, an alert on a media system of the aircraft in response to detecting the inconsistency between the statuses of the first aeronautical element.

2. The method of claim 1, wherein the at least two sources include air traffic controllers, controller-pilot data link communications (CPDLC), dispatch, chart/navigation/airport map databases, Notice to Airmen (NOTAM), automatic terminal information service (ATIS), common traffic advisory frequency (CTAF), and/or UNICOM.

3. The method of claim 1, wherein generating the alert includes displaying a graphic and/or text in a layer overlaying a moving map application on a display device onboard the aircraft, wherein the layer is configured to be disabled upon command.

4. The method of claim 1, further comprising generating, with the one or more processors of the controller, information indicating the inconsistency on a display device onboard the aircraft.

5. The method of claim 1, wherein the first aeronautical element is a runway or taxiway of an airport and the statuses indicated by each of the at least two sources is chosen from a group consisting of open, closed, and out of service.

6. The method of claim 1, wherein the first aeronautical element is a navaid, an airway, an airport, an obstacle, or an airspace.

7. The method of claim 1, wherein generating the alert includes transmitting control signals with the one or more processors of the controller to produce a graphic, text, and/or audio message with the media system onboard the aircraft.

8. The method of claim 1, wherein the alert includes a graphic and/or text displayed on a display of a flight management system of the aircraft.

9. The method of claim 1, wherein the alert includes a graphic and/or text displayed on a display of a multi-function control and display unit of the aircraft.

10. A system onboard an aircraft, comprising:
a communication system configured to provide for communication with one or more external sources;
a media system; and
a controller functionally coupled with the communication system and the media system, the controller configured to, with one or more processors:
receive aeronautical data from at least two sources, wherein the aeronautical data includes information indicative of statuses of one or more aeronautical elements, wherein at least a first source of the at least two sources is remote from the aircraft and the controller receives the aeronautical data from the first source via the communication system;
parse the aeronautical data to generate parsed aeronautical data having the information contained therein having matching formats;
identify statuses of the one or more aeronautical elements as indicated by each of the at least two sources in the parsed aeronautical data;
compare the statuses of the one or more aeronautical elements;
detect an inconsistency between the statuses of a first aeronautical element of the one or more aeronautical elements; and
generate, on the media system, an alert in response to detecting the inconsistency between the statuses of the first aeronautical element.

11. The system of claim 10, wherein the at least two sources include air traffic controllers, controller-pilot data link communications (CPDLC), dispatch, chart/navigation/airport map databases, Notice to Airmen (NOTAM), automatic terminal information service (ATIS), common traffic advisory frequency (CTAF), and/or UNICOM.

12. The system of claim 10, wherein the controller is configured to generate the alert by displaying a graphic and/or text in a layer overlaying a moving map application on a display device onboard the aircraft, wherein the layer is configured to be disabled upon command.

13. The system of claim 10, wherein the controller is configured to generate information indicating the inconsistency on a display device onboard the aircraft.

14. The system of claim 10, wherein the first aeronautical element is a runway or taxiway of an airport and the statuses indicated by each of the at least two sources is chosen from a group consisting of open, closed, and out of service.

15. The system of claim 10, wherein the first aeronautical element is a navaid, an airway, an airport, an obstacle, or an airspace.

16. The system of claim 10, wherein the controller is configured to generate the alert by transmitting control signals with the one or more processors thereof to produce a graphic, text, and/or audio message with the media system onboard the aircraft.

17. The system of claim 10, wherein the alert includes a graphic and/or text displayed on a display of a flight management system of the aircraft.

18. The system of claim 10, wherein the alert includes a graphic and/or text displayed on a display of a multi-function control and display unit of the aircraft.

19. An aircraft, comprising:
a communication system configured to provide for communication with one or more external sources;
a media system; and
a controller functionally coupled with the communication system and the media system, the controller configured to, with one or more processors:
receive aeronautical data from at least two sources, wherein the aeronautical data includes information indicative of statuses of one or more aeronautical elements, wherein at least a first source of the at least two sources is remote from the aircraft and the controller receives the aeronautical data from the first source via the communication system;
parse the aeronautical data to generate parsed aeronautical data having the information contained therein having matching formats;
identify statuses of the one or more aeronautical elements as indicated by each of the at least two sources in the parsed aeronautical data;
compare the statuses of the one or more aeronautical elements;
detect an inconsistency between the statuses of a first aeronautical element of the one or more aeronautical elements;
generate an alert in response to detecting the inconsistency between the statuses of the first aeronautical element by transmitting control signals to produce a graphic, text, and/or audio message with the media system; and
generate information indicating the inconsistency on the media system.

20. The aircraft of claim 19, wherein the alert includes a graphic and/or text displayed on a display of a flight management system of the aircraft, displayed on a display of a multi-function control and display unit of the aircraft, or displayed as a layer overlaying a moving map application on a display device onboard the aircraft.
